(19) United States
(12) Patent Application Publication
(10) Pub. No.: US 2005/0022171 A1
(43) Pub. Date: Jan. 27, 2005

(54) Transformation of object trees, especially in mes systems

(76) Inventors: Dirk Langkafel, Erlangen (DE); Elmar Thumer, Nurnberg (DE)

Correspondence Address: Siemens Corporation;Intellectual Property Department, 170 Wood Avenue South, Iselin, NJ, 08830, US

(21) Appl. No.: 10/499,738

(22) PCT Filed: Nov. 28, 2002
(86) PCT No.: PCT/DE02/04374

(30) Foreign Application Priority Data
Dec. 12, 2001 (DE) 101 61 115.3

(51) Int. Cl. G06F 9/45

(52) U.S. Cl. 717/136

(57) ABSTRACT

A system and method for the transformation of object trees, especially in MES systems, wherein the source tree and target object trees are represented in a common meta-object model of a software system, especially a framework. The source object tree is transformed into the target object tree by adjustment. Transformation occurs directly in the object of the meta-object model (component), thereby enabling communication between connected applications by means of pure data exchange.

### CROSS REFERENCE TO RELATED APPLICATIONS

This application is the US National Stage of International Application No. PCT/DE02/04374, filed Nov. 28, 2002 and claims the benefit thereof. The International Application claims the benefits of German application No. 10161115.3 filed Dec. 12, 2001, both of the applications are incorporated by reference herein in their entirety.

### FIELD OF INVENTION

The invention relates to a system and a method for the transformation of object trees, especially in MES systems, wherein the source tree and target object tree are represented in a common meta-object model of a software system and the software system is stored on at least one computer unit.

Furthermore, the invention relates to a system and a method for planning the aforementioned transformation, and a corresponding computer program, a data carrier and a data processing device.

### BACKGROUND OF INVENTION

If heterogeneous applications, e.g. MES applications, are connected to each other in the software system, the objects or object trees of the particular applications are represented in the meta model of the software system, mostly in different ways, even if the objects or object trees semantically agree. Communication between the applications is made difficult by this various representation.

The use of Manufacturing Execution Systems (MES), as they are called, for the automation of production or manufacturing sequences is known from “Software für die Automatisierung-Transparenz über die Abläufe schaffen” [Software for automation—Creation of transparency for processors], an article by Dirk Kozian in Elecktronik fur die Automatisierung 11, 17.11.1999. These systems integrate the automation level (controls) with the ERP (Enterprise Resource Planning) systems of the enterprise resource planning level. Manufacturing execution systems are systems that, for example, prepare information for the optimization of production sequences. The manufacturing execution systems must supplement the rough planning data of the ERP systems by including plant-specific and current fine planning data and pass this on correspondingly to the subordinate automation level, and they also have the task of receiving production-relevant information from the automation level, processing this and passing it on to the enterprise resource planning level. MES systems thus fulfill the task of vertical integration between the enterprise resource planning level and the automation level. Typical single tasks of MES systems are Enterprise Asset Management, Maintenance Management, Information Management, Scheduling, Dispatching and Trace and Track. These tasks are each carried out by MES components or MES applications.

Because of the software and data-technical heterogeneity of MES applications these can only be integrated into a common system or project with great difficulty and data exchange between these applications is possible only at considerable expense.

The integration of software components by adaptors or by wrapping (packaging) into a software system is known from “Massive Wiederverwendung: Konzepte, Techniken und Organisation” [Massive reuse: Concepts, techniques and organization], an article by Ulrich Lindner in OBJEKTspektrum 1/96, p. 10-17. The object in this case is to increase the reusability of software components.

The use of XML (extensible Markup Language) for data exchange between external systems, and thus the performance of transformations, is known from “XML—Schlüsseltechnologie für Softwarearchitekturen” [XML—Key technology for software architecture], an article by Alexander Jung in OBJEKTspektrum 1/2001, p. 71-74. As part of the XML family, a standard procedure for transformation of XML documents, i.e. XSL (Extensible Stylesheet Language) transformations, is defined. XSL transformations also enable tree transformations to be described, but only if the objects of the trees are in XML format and the particular XML format is known to a user. If a user wants to perform a transformation of an object tree, he requires the associated representation of the objects in XML format and he must define the transformation at the XML level. This means expense because the user must first provide the corresponding XML formats of the objects.

### SUMMARY OF INVENTION

The object of this invention is to provide a system and a method that enables transformations of object trees to be performed directly-at the domain level of the user, with the definition of the transformations being convenient and simple for the user.

In accordance with the invention, the aforementioned objective is achieved for a system by the features of claim 1. In this case the transformation of objects, or object trees, takes place in the domain world of the user, i.e. the user can abstract from the format on which the objects are based. A further advantage is that the object structures are brought by the transformation to a form that can be understood by the recipients (e.g. other applications) of these object structures. It is in fact often the case that objects that are semantically the same (e.g. production jobs) are represented differently in a common meta-object model. By means of the transformations, objects with the same semantics are also provided with uniform representations. This enables communication between different applications by means of a pure data exchange.

A first advantageous embodiment of this invention for a system is that the transformation can be performed by a user in the basic domain. If the transformation takes place directly at the domain level of the user, the user can abstract from the internal formats of the objects or object trees. The effectiveness of a user is increased because he remains in his known world (known nomenclature, known objects etc.) when creating solutions. A user therefore does not have to transform the objects to be transformed at the level of their internal format and then retranslate them back into the domain world.

A further advantageous embodiment of the invention for a system is that the rules can be represented as objects of the software system. The objects thus appear to the user as part of the software system. A user can also deal with the rules in the same way as objects, e.g. link them graphically.

A further advantageous embodiment of the invention for a system is that the rules can be defined by the user. This increases the flexibility for a user and the user can define rules himself that are suitable for the basic structures and problems.

A further advantageous embodiment of the invention for a system is that existing rules can be used for defining rule operators and/or existing rules. This makes the creation and/or changing of rules easier for a user.

A further advantageous embodiment of the invention for a system is that the software system is realized by at least one framework program. This means that the advantages of a framework program are available. A framework defines the architecture of a family of software systems, makes the basic modules for creation of these software systems available and defines their interaction. Frameworks save development time and development costs.

A further advantageous embodiment of the invention for a system is that the source and target object trees are determined by the object models of the adapters. Adapters are an abstraction level higher than wrappers. They offer a common view of connected applications. An adapter offers functionality for starting, operating etc. the components to be connected. An adapter in the language of design patterns is a “facade”. A wrapper on the other hand maps the API (Application Programmable Interface) of an external component (e.g. an MES application of a third-party supplier) to the object model of a software system. Thus, for example, a method of the software system is obtained from a method of the API of the external component or an integer data type of the software system is obtained from an integer data type of the API of the external component, etc. By means of adapters, the objects of the applications to be integrated are mapped to the meta-object model of the software system and represented in the meta-object model as a source or target object tree. If the adapters now specify the structure of these trees, a succeeding transformation from source to target object tree can easily take place, or can even be automated.

In accordance with the invention, the aforementioned object for a system for planning transformations of object trees is solved by the features of Claim 8. The user is very efficiently supported by a planning environment for the definition of transformations. The user then no longer has to program, but instead he can plan the transformations. Planning environments with a graphic user interface and/or drag and drop mechanisms for linking objects are very convenient for a user.

In accordance with the invention, the aforementioned objective is achieved for a method by the features of Claim 9. In this case the transformation of objects, or object trees, takes place in the domain world of the user, i.e. the user can abstract from the format on which the objects are based. A further advantage is that the object structures are brought by the transformation to a form that can be understood by the recipients (e.g. other applications) of these object structures. It is in fact often the case that objects that are semantically the same (e.g. production jobs) are represented differently in a common meta-object model. By means of the transformations, objects with the same semantics are also provided with uniform representations. This enables communication between different applications by means of a pure data exchange.

A first advantageous embodiment of this invention for a method is that the transformation can be performed by a user in the basic domain. If the transformation takes place directly at the domain level of the user, the user can abstract from the internal formats of the objects or object trees. The effectiveness of a user is increased because he remains in his known world (known nomenclature, known objects etc.) when creating solutions. A user therefore does not have to transform the objects to be transformed at the level of their internal format aid then retranslate them back into the domain world.

A further advantageous embodiment of the invention for a method is that the rules can be represented as objects of the software system. The objects thus appear to the user as part of the software system. A user can also deal with the rules in the same way as objects, e.g. link them graphically.

A further advantageous embodiment of the invention for a method is that the rules can be defined by the user. This increases the flexibility for a user and the user can define rules himself that are suitable for the basic structures and problems.

A further advantageous embodiment of the invention for a method is that existing rules can be used for defining rule operators and/or existing rules. This makes the creation and/or changing of rules easier for a user.

A further advantageous embodiment of the invention for a system is that the software system is realized by at least one framework program. This means that the advantages of a framework program are available. A framework defines the architecture of a family of software systems, makes the basic modules for creation of these systems available and defines their interaction. Frameworks save development time and development costs.

A further advantageous embodiment of the invention for a method is that the source and target object trees are determined by the object models of the adapter. Adapters are an abstraction level higher than wrappers. They offer a common view of connected applications. An adapter offers functionality for starting, operating etc. the components to be connected. An adapter in the language of design patterns is a “facade”. A wrapper on the other hand maps the API (Application Programmable Interface) of an external component (e.g. an MES application of a third-party supplier) to the object model of a software system. Thus, for example, a method of the software system is obtained from a method of the API of the external component or an integer data type of the software system is obtained from an integer data type of the API of the external component, etc. By means of adapters, the objects of the applications to be integrated are mapped to the meta-object model of the software system and represented in the meta-object model as a source or target object tree. If the adapters now specify the structure of these trees, a succeeding transformation from source to target object tree can easily take place, or can even be automated.

In accordance with the invention, the aforementioned object for a method for planning transformations of object trees is solved by the features of Claim 16. The user is very efficiently supported by a planning environment for the definition of transformations. The user then no longer has to program, but instead he can plan the transformations. Planning environments with a graphic user interface and/or drag and drop mechanisms for linking objects are very convenient for a user.

A further advantageous embodiment of the invention is that the method in accordance with the invention is implemented by a computer program. This means that any modifications or adaptations can be easily implemented.

A further advantageous embodiment of the invention is that the computer program for the method in accordance with the invention is stored on a data carrier. This means that the method is easily handled with regard to logistics and distribution.

A further advantageous embodiment of the invention is that the computer program for the method in accordance with the invention is installed on a data processing device. This increases the performance.

### BRIEF DESCRIPTION OF THE DRAWINGS

Further advantages and details of the invention are now given in the following description of advantageous examples of embodiments, in conjunction with the illustrations. Where elements in different illustrations with the same function are described, these are identified by the same reference characters. The illustrations are as follows.

FIG. 1 An overview of the “Enterprise pyramid” with three control levels.

FIG. 2 An overview showing an example for MES solutions with software and hardware units.

FIG. 3 The central position of the framework program connecting the software applications.

FIG. 4 An example of the transformation of objects.

FIG. 5 An example of the transformation of objects with the aid of mathematical objects.

FIG. 6 The principle of construction of an adapter,

FIG. 7 A “component” as a meta-object model in UML notation.

### DETAILED DESCRIPTION OF INVENTION

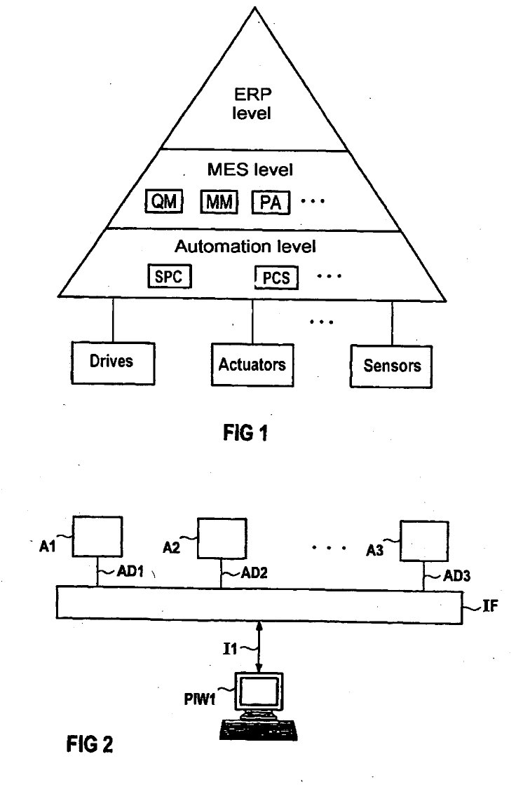

FIG. 1 is an overview of the three control levels normally found in a producing or manufacturing enterprise. The pyramid form expresses the fact that a compression of information takes place upwards. The highest level is the ERP (Enterprise Resource Planning) level. Business management and sales tasks in a business normally take place at this enterprise resource planning level (e.g. finance, sales, personnel, reporting). Logistic tasks overlapping production plants (e.g. order and material management) also take place at this level. The SAP R/3 is an ERP system very frequently used at enterprise resource planning level.

The lowest level of the pyramid is the automation level (controls). Stored program controllers (SPC) in conjunction with visualization and process control systems (PCS) are normally used at this level. The drives, actuators and sensers of the production and/or manufacturing devices are directly connected to the systems at this level.

The connecting element between the ERP level and the automation level is formed by the MES level. The applications of the MES level thus ensure a vertical integration between the ERP level and the automation level. The MES applications must supplement the rough planning of the ERP systems with fine planning specific to the production plants and pass this on to the systems of the automation level, and it is also the task of the MES applications to receive production-relevant data of the automation level, process it and pass it on to the ERP level (enterprise resource planning level).

Typical MES applications are Quality Management (QM), Maintenance Management (MM), Performance Analysis (PA), Process Management, Labor Management, Asset Management. The three dots in each case in FIG. 1 show that other elements (applications, systems etc.) can be located at one level.

MES systems or ERP systems usually contain a run-time system to control the timing of the sequence of the components involved (part components, modules, tasks, processes of the operating system etc.), and an engineering system for creating and editing programs for implementation in the run-time system.

FIG. 2 is an example of an overview showing software and hardware units for MES solutions. The individual MES applications A1 to A3 are connected via adapters AD1 to AD3 to a framework program IF. A user workplace PIW1 is connected to the framework program IF by means of a bi-directional information path I1 and can thus administer and monitor the attached or integrated MES applications. The user workplace PIW1 usually consists of a display device (monitor, display, etc.), a data processing system (e.g. PC) with a processor and storage devices and also input units (keyboard, mouse, etc.). MES applications A1 to A3 and the framework program IF can run on their own data processing units or processors, but it is also possible for them to run on the data processing unit of the PIW1.

The MES applications A1 to A3 are each connected to the framework program IF by means of adapters AD1 to AD3. The adapters are therefore the connecting modules between the framework program IF and the applications. Heterogeneous applications can also be connected to each other through the adapters and by integration with the framework program IF it is possible to communicate and exchange data between the applications. The adapters are software modules that establish connections to various applications. In typical integration scenarios this is integration to systems from the MES, ERP, SCADA or Controls world. An adapter offers the functionality to start and to operate etc., a connected component An adapter permits access to data and functions of the applications connected, makes certain runtime data available and enables engineering information to be loaded from the connected application. Adapters can differ with regard to their construction and scope. Thus, adapters can, for example, be permanently programmed or they can be configured or modeled. They can also differ with regard to the facilities for access to the connected applications, and adapters can, for example, permit only one technical data access, but it is also possible for adapters to permit access to higher-value business processes. During start-up, the adapters are loaded with the stored models and status information. For the run-time a check is then made to determine if and how the different integrated applications match. By means of visualization or monitoring components it is possible to request the status of an adapter and to display this at the user workplace PIW1 (including graphically). By means of adapters, both the system and the user obtain a standardized uniform view of applications (depending on which abstraction level is present with the adapters)

A further possibility of integrating software components is to use wrappers. A wrapper maps the API (Application Progammable Interface) of an external component (e.g. an MES application) to the object model of the framework program. Thus, for example, a method of the framework program is obtained from a method of the API of the external component and an integer data type of the framework program is obtained from an integer data type of the API of the external component.

In addition to MES applications, applications from the enterprise resource planning level and/from the automation level (controls level) can also be integrated by means of the framework program IF and monitored or administered via the workplace PIW1 (the acronym PIW stands for Personalized Industrial Workplace). The framework program IF thus forms an integration platform for the complete industrial area. Different applications from the enterprise resource planning level, the MES level and automation level can be simply and economically integrated by the framework program IF with the aid of adapters and/or wrappers. The framework program IF is thus to be seen as a middleware platform and as a manufacturing application integration tool. From the workplace PIW1, a user (e.g. the plant operator) can see the particular states of the applications to be monitored and also intervene with respect to data and methods of the applications, and furthermore he can link applications to each other by means of this intervention.

The framework program IF thus permits a vertical integration of applications from different enterprise levels to be achieved and also enables the framework program IF to achieve a horizontal integration of applications of the MES level.

The workplace PIW1 represents “one window to the world” from the enterprise, for a user at the front end of MES applications or other applications. This means that the workplace by a common uniform interface enables an integrative access to different, even heterogeneous, applications in the enterprise. The user of the workplace PIW1 can thus monitor and administer all integrated MES or other applications from this one workplace. This workplace can be connected to the applications by the Internet, the intranet, LAN (Local Area Network) or other conceivable connections. It is also possible to arrange this workplace as a mobile station, e.g. mobile terminal (PDA, mobile phone). This mobility would have yet further advantages for a user.

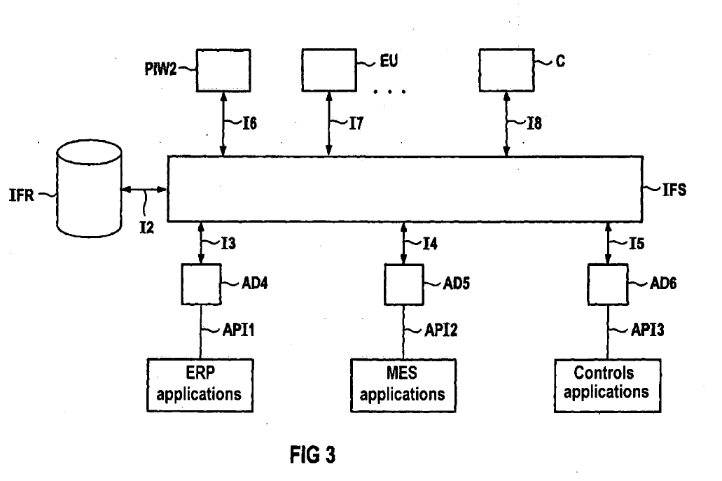

FIG. 3 shows the central position of the framework program connecting the software applications. To realize the system or method in accordance with the invention, it is advisable to select a client-server architecture. The framework program (IF; FIG. 2) can in this case be on a single server or any number of servers that can be distributed within an IT environment. FIG. 3 shows the framework program (IF; FIG. 2) on a server IFS (Industrial Framework Server). The clients, connected by the bidirectional information path I2-I8, are linked to the central server IFS. The clients include the applications from the ERP, the MES and the automation level. These applications are shown in FIG. 3 on the bottom border of the illustration. These applications are connected to the framework program (IF; FIG. 2), and thus to the server IFS, by adapters AD4-AD6. The adapters AD4-AD6 are connected to the applications through the API interfaces API1-API3 (API stands for Application Programmable Interface). An application programmable interface forms an interface between a set of commands. APIs are also used for the conversion of parameter lists from one format to a different format and during the interpretation of arguments in one or both directions. The APIs are, so to speak, the cement between the applications and adapters. The connection between the adapters AD4-AD6 and the framework program (IF; FIG. 2) (shown in FIG. 3 by the bi-directional information paths I3-I5) is achieved by means of suitable data formats (e.g. XML), suitable protocols (XOP, OPC, etc) and suitable transport mechanisms (e.g. DCOM or MSMQ). HTTP (Hyper Text Transfer Protocol) can also be used for this. The SOAP (Simple Object Access Protocol) protocol based on XML (extensible Markup Language) can be used for the integration of adapters AD4-AD6 to the framework program (IF; FIG. 2) or the associated server IFS. Clients or applications that support the ActiveX documents or calls can be integrated into the framework program (IF; FIG. 2) or the server IFS with particular advantage. The applications can be connected to the framework program not only by adapters but also by wrappers or other integration mechanisms.

The Repository IFR (Industrial Framework Repository) can be connected to the server IFS as a further client. FIG. 3 shows the connection through the bi-directional information path I2. The repository IFR is used to keep data secure and constant. This data can be accessed by calling up methods. The repository is used mainly to store objects, methods and runtime data.

Other clients of the server IFS are shown in the top half of the illustration. The personalized industrial workplace PIW2 and any existing engineering environment EU are clients of the server IFS. The personalized industrial workplace PIW2 is connected by the bi-directional information path I6 to the framework program (IF; FIG. 2) or to the server, and the engineering environment EU correspondingly through the bi-directional information path I7. The three dots show that other clients can be linked to the server IFS. FIG. 3 shows that a further client C is also connected through the information path I8 to the server IFS.

The clients IFR, PIW2, EU, C are connected accordingly via APIs or common data formats (e.g. XML), common protocols (XOP, OPC, etc.) and common transport mechanisms (e.g. DCOM, HTTP or MSMQ).

The adapters AD4-AD6 used enable access to data and also to methods of individual applications that connect them to the framework program (IF; FIG. 2). These adapters are very flexible and are not defined for individual special protocols or special transport mechanisms. If the adapters are used in a runtime environment, they are then configured to make sure that certain necessary data from an application is present at the correct time point in the server environment. This can, as already stated, be achieved by different protocols and transport mechanisms. In a run-time environment, there can be several adapters that also have small server properties (such as the implementation of workflows, the provision of various communication possibilities, etc.). These adapters can run on the particular application computer but they do not have to run just on one machine, they can also be distributed.

Software applications, particularly MES (Manufacturing Execution Systems) applications, are often present in a heterogeneous form, e.g. they can have different data formats or object models or they are realized in different program languages. The system or method in accordance with the invention enables such heterogeneous applications to be integrated with the aid of a framework program. Communication between these applications is based on a communication means such as HTTP, DCOM, MSMQ, etc. Communication, i.e. data exchange, between the applications is, however, independent of these communication means in that the applications can abstract from the application means.

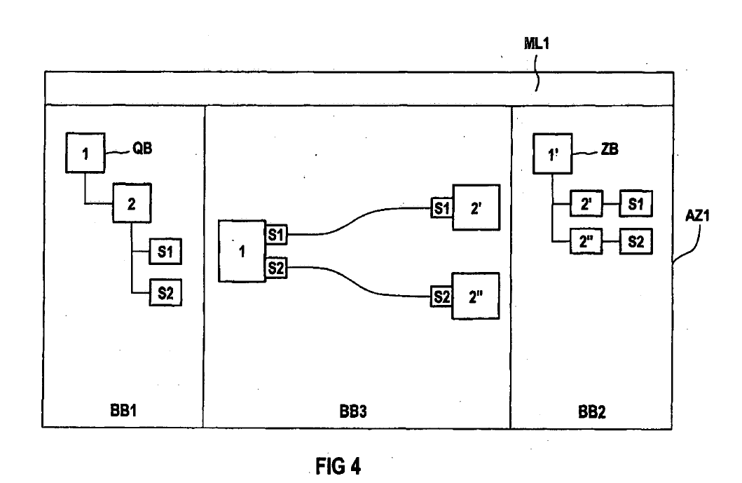

FIG. 4 shows an example of the transformation of objects or object trees. Objects that are semantically the same can be represented completely differently in a common meta-object model. To enable communication by means of pure data exchange, it is necessary to convert the object structures to be exchanged to a form that is understandable for the particular recipient. FIG. 4 is a schematic showing the interface of a planning environment for the transformation of objects or object trees with a display device AZ1. The object trees shown in screen areas BB1 and BB2 represent objects that are semantically the same (e.g. a production order) but that are represented differently. The source tree QB consists of a root 1 and the element 2 below it, that in turn has sub-elements S1 and S2. The target tree ZB has 1′ as the root and attached underneath that elements 2′ and 2″. The element 2′ is connected to element S1, element 2″ is connected to element S2. The tree representations QB and ZB belong to applications (e.g. MES applications) that were mapped by means of adapters of the meta-model of the basic software system (e.g. frameworks). Because both tree structures are represented in a different form in the meta-object model even though they are semantically the same, communication between the applications to which they belong is still not effectively possible in this form. An effective communication is enabled in that one object tree is mapped on the other. In the illustration in FIG. 4, the source tree QB is transformed to the tree ZB. How this transformation takes place is shown in screen area BB3. In this case, elements S1 and S2 represent objects (e.g. variables) that have the same significance in both trees QB and ZB. Screen area BB3 shows how a transformation can take place where the objects S1 and S2 of the source tree QB and target tree ZB are semantically the same. The display device AZ1 can also have a menu bar ML1 as a further screen area, on which functions (e.g. buttons) are represented that the user can use for the transformation. A monitor or display unit is normally used as the display device. The user can operate or activate the elements of the display device by means of an input means such as a mouse or keyboard. The display device AZ1 can also have other screen areas. It is thus, for example, conceivable that the screen area BB3 is further subdivided, and also other menu bars ML1 can be present. Transformations that have been defined by the user can be saved and reused for later applications. A user can also define rules for performing these transformations. A user can also store these rules and use them for subsequent transformations.

It is also conceivable that a rule becomes part of the meta-object model of the basic software system and is then available as an object to a user. The aforementioned rule objects are automatically created during the definition of a transformation. Mathematical functions (addition, subtraction, sine, cosine, etc.) can be used to define transformations, but timers or other adapters (e.g. Excel) can also be used. Drag and drop mechanisms enable the transformations and rules to be very easily created. By means of the transformation described above, two semantic representations (e.g. object trees), that were brought to the meta-object model by the adaptation, are converted into each other. In this, it is very easy for the adapted applications (e.g. different MES applications) to communicate with each other. With the transformation described, the objects or object trees are mapped directly to each other and not the representations of these objects in any format structures. The transformation can thus take place in the domain world of the user and a user can extract from the internal representation of the objects, i.e. from the internal formats. The planning or engineering environment described here can, for example, be realized as a client in a framework or in the software system. However, it is also possible for this environment to be realized on a stand-alone PC.

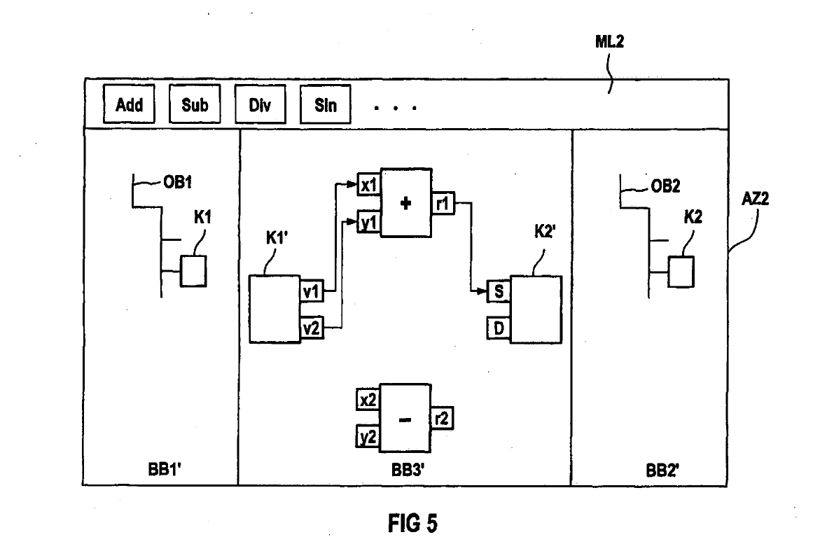

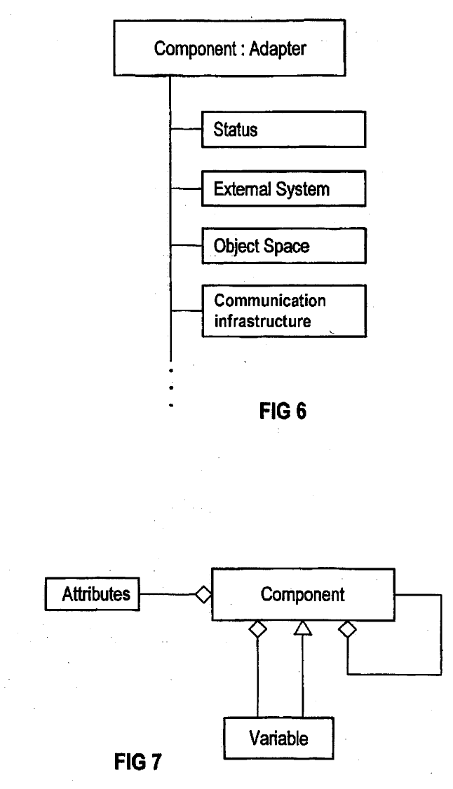

FIG. 5 shows an example of the transformation of objects or object trees with the aid of mathematical objects. Screen areas BB1′ and BB2′ contain object trees OB1 and OB2 respectively, that are to be transformed into each other. As an element, OB1 contains in its structure component K1, OB2 contains component K2 as an element in its structure. By means of a drag and drop mechanism the components K1 or K2 are shifted to working area BB3′ and in working area BB3′ component K1′ corresponds to component K1 of object tree OB1 and component K2′ corresponds to component K2 of object tree OB2. A transformation is to be performed between these components K1′ and K2′. K1′ contains variables V1 and V2 and K2′ contains variables S and D. The menu bar ML2 shows operators, e.g. addition, subtraction, division, sine that can be used to define a transformation. Further mathematical operators can also be made available for the definition of a transformation, such as multiplication, tangent, arc tangent, cosine, exponential function, logarithm, root function, signum, absolute function, etc. Timers can also be used to define transformations. Timers, for example, provide the actual time or also definable time cycles that can be manipulated, for example with the aid of the aforementioned mathematical operations. It is thus conceivable to add values obtained from a timer to other values before forwarding them onwards. The user can also use his own operators or implement operations using script or the implementation of COM objects. In screen area BB3′, it can be seen that the two variables V1 and V2 of component K1 or K1′ are added together. The result of this addition (shown by variable R1) is connected to the variables S of component K2′ or K2. When such a transformation is created, a rule object is produced that can also be used again for subsequent transformations. These rule objects can be stored, for example in the communication structure of an adapter (see FIG. 6) and used. By using the drag and drop to connect object trees, or objects of object trees, to each other, by moving them onto working area BB3′, the connections for the transformation are automatically generated, i.e. this connection is created in the background for the objects to be connected.

Because graphical planning using a drag and drop mechanism is possible, the user no longer needs to program individual connections but can instead plan them graphically. This increases the effectiveness of a user enormously. After a transformation, two object trees, that are to be connected to each, are present in a common representation. Because of this, it is very easily possible to establish a communication, based on a pure data exchange, between these objects, i.e. between the associated applications. The performance of a communication connection of this kind is very high.

FIG. 6 shows the principle of the construction of an adapter. Each adapter is a special component with the particular property that the component of an adapter in each case runs in its own process. Each adapter already has its own specific default structure that is again shown as a tree structure of objects of the framework program, i.e. components and variables, and makes available the particular points at which the adapter can output certain information. An example is information on the status of the adapter (is the adapter connected to his application, is the application running, version information etc.). Furthermore, an adapter can output information on the external system, i.e. the external application. By means of the “object space” an adapter can output structures which the other adapters or other applications can access. An adapter can also output information regarding a communication infrastructure. Communication infrastructures are objects for the transmission, reception and transformation of messages, as well as mechanisms for undertaking routing and logging the data exchange of the adapter. Furthermore, the communication infrastructure of an adapter has something called inports and outports that physically receive or transmit the messages. An adapter is present as a separate process of the operating system, i.e. if an adapter crashes this has no effect on other adapters. An adapter is thus a separate application complete in itself that can be called up on its own.

Adapters and wrappers are mechanisms for the integration of software components into a software system. A wrapper maps the API (Application Programmable Interface) of an external component or an application to be integrated into the object model of the software, in this case a framework program (IF; FIG. 2). Thus, for example, a method of the framework program is obtained from a method of the API of the application to be integrated and from an integer data type of the API of the application to be integrated an integer data type of the framework program is obtained, etc. A wrapper thus brings the API of the application to be integrated into the language, nomenclature and object world of the framework program.

An adapter on the other hand is an abstraction stage higher than a wrapper. Adapters represent a standardized view of the applications to be integrated, and the framework program in which the application to be integrated is attached can be abstracted from this application. An adapter provides functionality for starting, operating and handling the system to be integrated, i.e. the application to be integrated. With the aid of the adapter it is possible, for example, for a user to use an SAP application without being an SAP expert. SAP applications are mapped to the object model of the framework program by means of the IDOC adapter and are then used as objects of the framework program (component IDOC).

By means of the system and method in accordance with the invention, two applications (e.g. MES applications) can be brought together peer-to-peer without it being necessary to program such a connection in a peer-to-peer manner in each case. In accordance with the invention, these connections are planned by establishing a connection.

The rules used for a transformation can be part of an adapter or the rules can be stored on an adapter as information and brought into the system.

There are, for example, adapters for spreadsheets (e.g. Excel) or other commercial off-the-shelf programs.

FIG. 7 shows the object structure of a “component” as a meta-object model of the framework program (IF; FIG. 2) in UML (Unified Modeling Language). With a system and method in accordance with the invention, the software applications to be integrated and the basic communication means (e.g. HTTP, MSMQ, etc.) are mapped to an object model of the framework program (IF; FIG. 2). In this way, applications that are heterogeneous in themselves have a common object model. Thus all methods, data structures, objects etc. of the external applications to be integrated are represented in a common object model. This object model is very generic and represents a meta-object model. The core of this object model consists of an object type called a “component”. A component can in turn aggregate other components and/or special types of components, called variables, to which certain values are assigned in operation. Components and variables can each also possess additional attributes.

This object model forms the basis of the adaptation of MES applications or other applications. This means that the structures of the applications can be translated or mapped in structures of this object model. All the applications to be integrated are represented within the framework program (IF; FIG. 2) in the display of this object model. The basic communication means are also mapped to this generic object model. In the framework program (IF; FIG. 2), all the applications and all the basic communication means are now represented in a uniform, homogeneous object model. In this way, communications between applications can be set up very simply and easily.

In FIG. 7, the generic “component” representing the core of the object model is shown in UML notation.

The square boxes represent parts of the object models. An aggregation (is part from-connection) is shown by a diamond connection and heredity (is in-connection) is represented by a triangular connection. The representation in FIG. 7 thus shows that a component can consist of several components and, furthermore, a component can be part of a different component. By means of the diamond connection, a component is connected to attributes and variables. This means that a component can have attributes and variables. Attributes are descriptive data. All objects of a class possess the same attributes but generally different attribute values. An attribute value is a value assigned to an attribute from its value range. A variable can assume values of certain data types (e.g. integer, real, etc.). As shown by the diamond connection, a component can contain several variables. A component can also be an upper class of a variable, as shown by the triangular connection. This means that a variable can be a derived component. The diamond and triangular relationships can also contain cardinalities.

By means of mapping mechanisms, such as adapters or wrappers, the software applications to be integrated and the basic communication means are mapped to this generic object structure, i.e. “component” structure of the framework program (IF; FIG. 2).

In conclusion, the invention relates to a system and a method for the transformation of object trees, particularly in MES systems, with the source and target object trees being represented in a common meta-object model of a software system, especially of a framework. The source object tree is transformed into the target object tree by rules. The transformation takes place directly on the objects of the meta-object model (component). In this, communication between connected applications is possible by means of pure data exchange.

The system or methods described in the foregoing can be implemented as a computer program in languages known for that purpose. An implemented computer program of this kind can be communicated in a known manner via electronic data paths and can also be stored and transported on data carriers.

1.-19. (cancelled)

20. A system for the transformation of object trees, wherein the source object tree and the target object tree are represented in a common meta-object model of a software system, the system comprising:
a computer unit for storing the software system;
a transformation device for transforming the source object tree into the target object tree by rules present in the software system, wherein the transformation is directly performed on the objects of the meta-object model.

21. A system in accordance with claim 20, wherein the system is a MES System.

22. A system in accordance with claim 20, wherein the transformation is performed in user domain.

23. A system in accordance with claim 20, wherein the rules are represented as objects of the software system.

24. A system in accordance with claim 20, wherein the rules can be defined by the user.

25. A system in accordance with claim 20, wherein operators and/or existing rules can be used to define the rules.

26. A system in accordance with claim 20, wherein the software system is realized by a framework program.

27. A system in accordance with claim 20, wherein the source and target object trees are specified by the object model of a adapter.

28. A system for planning transformations of object trees in MES systems, wherein the source object tree and the target object tree are represented in a common meta-object model of a software system, the system for planning transformations comprising: wherein
a first screen area of a display device for displaying a source object tree;
a second screen area of the display device for displaying a target object tree;
a third screen area of the display device for representing a working area for positioning nodes of the object trees; and
a fourth screen area of the display device for displaying operators and/or rules, that can be positioned on the working area, wherein
a transformation is accomplished on the working area by switching the symbols located on the working area.

29. A method for transformation object trees, the method comprising:
representing the source object tree and the target object tree in a common meta-object model of a software system; and
transforming the source object tree to the target object tree by rules present in the software system, wherein
the transforming is defined on the objects of the meta-object model, and wherein
the transforming is performed directly on the objects of the meta-object model.

30. A method in accordance with claim 29, wherein the transformation is performed in a user domain.

31. A method in accordance with claim 29, wherein the rules are represented as objects of the software system.

32. A method in accordance with claim 29, wherein the rules are defined by a user.

33. A method in accordance with claim 29, wherein operators and/or rules already present are used to define the rules.

34. A method in accordance with claim 29, wherein the software system is realized by at least one framework program.

35. A method in accordance with claim 29, wherein the source and target object tree are specified by the object model of a adapter.

36. A method in accordance with claim 29, wherein the method is implemented by a computer program.

37. A method in accordance with claim 36, wherein the computer program is stored on data carrier.

38. A method in accordance with claim 36, wherein the computer program is installed on a data processing device.

39. A method for planning transformations of object trees in MES systems, the method comprising:
representing the source object tree and the target object tree in a common meta-object model of a software system;
displaying a source object tree in a first screen area of a display device;
displaying a target object tree in a second screen area of the display device;
providing a working area for positioning nodes of the object trees on a third screen area of the display device; and
planning a transformation on the working area by switching the symbols present on the working area.

40. A method for planning transformations according to claim 39, further comprising:
displaying operators and/or rules in a fourth screen area of the display device; and
positioning the operators and/or rules on the working area.
